(19) United States
(12) Patent Application Publication
(10) Pub. No.: US 2005/0211178 A1
(43) Pub. Date: Sep. 29, 2005

(54) Bird feeder guard

(75) Inventor: John Stone, Southboro, MA (US)

Correspondence Address: PERKINS, SMITH & COHEN LLP, ONE BEACON STREET, 30TH FLOOR, BOSTON, MA, 02108, US

(73) Assignee: Opus, Inc., Bellingham, MA (US)

(21) Appl. No.: 11/031,146

(22) Filed: Jan. 7, 2005

Related U.S. Application Data
(60) Provisional application No. 60/534,911, filed on Jan. 8, 2004.

(51) Int. Cl. A01K 61/02

(52) U.S. Cl. 119/57.9

(57) ABSTRACT

Disclosed herein is a bird feeder with a guard protecting against contamination of the bird feed contained within the feeder. The feeder comprises a housing that defines a feed chamber. This housing includes a lid, wherein the lid has at least one opening. This opening can be used by birds to access food within the feeder. As mentioned above, the feeder includes a guard. This guard is formed integrally or it can be a separate part attached to the lid near or at an opening. In one aspect, the guard includes an occluding element, wherein this occluding element is in communication with a biasing element. The occluding element has a first position which occludes an opening sufficiently to prevent animals other than certain birds from gaining access to said feed chamber. This occluding element is capable of being movable to a second position by applied external pressure to the occluding element thus permitting access to said chamber. As the applied pressure is withdrawn, the occluding element substantially returns to its first position.

### RELATED APPLICATIONS

This application claims priority to and the benefit of U.S. Provisional 60/534,911 filed Jan. 8, 2004.

### FIELD OF THE INVENTION

This invention relates generally to an access device for a bird feeder, and, more particularly, to a bird feeder having a guard to prevent certain animals, such as insects, access food secured within a chamber of the feeder.

### BACKGROUND OF THE INVENTION

It is not unusual to find a bird feeder that is designed such that a squirrel or other pest cannot access the food contained within a chamber of the bird feeder. However, squirrels and other large pests are not the only problem. Insect feeding and contamination is another familiar problem especially with nectar feeders. A frequent approach to this problem is the use of a moat. These moats are designed such that insects cannot traverse the moat and gain entry into the feed chamber. However, these moats are not always successful in thwarting off the persistence of insects. Additionally, these moats do not appear to preclude flying insects from gaining entry into the feed chamber. Moreover, these moats require constant attention such as refilling and unpleasant cleaning.

Other attempts have been made to prevent unwanted guests from entering a feed chamber in a bird feeder. For example, there is a complex bird feeder having an annular housing that defines an opening and a plurality of panels in which these panels are circumferentially interposed within the housing. The bird penetrates this device and gains access to the food by use of the bird's bill. However, there are problems associated with this approach. For example, the entry into the food chamber is protected by a series of panels. In a closed position, these panels are adjacently disposed next to one another. As a bird's bill enters the housing it separates the panels from one another, fanning the panels in an outward direction (away from the orifice of the housing). It is quite conceivable that after a few rounds of this mechanical stretching of the panels by the bird's bill, the integrity of the panels will be compromised thus preventing full closure of the opening. This simply invites insects into the food chamber, resulting in the contamination of the feed within.

Currently, there exists a need for a bird feeder that has an effective and reliable guard to prevent contamination of the feed contained within a chamber of a bird feeder.

### BRIEF SUMMARY OF THE INVENTION

The present invention relates to a bird feeder. In particular, the invention pertains to a bird feeder guard that serves as a barrier to contaminating animals, including insects, from entering a feed chamber of a bird feeder.

In one embodiment, the present invention is directed toward a bird feeder. In one aspect, the feeder comprises a housing that defines a feed chamber. This housing includes a lid, wherein the lid has at least one opening. This opening can be used by birds to access food within the feeder. In another aspect, the feeder of the present invention includes one or more guard units. The guards are formed integrally with the lid near or at an opening. In one aspect, the guards include an occluding element, wherein this occluding element is in communication with a biasing element. The occluding element has a first position (closed position) which occludes said opening sufficiently to prevent animals other than certain birds from gaining access to said feed chamber. This occluding element is capable of being movable to a second position (opened position) by applied external pressure to the occluding element thus permitting access to said chamber. As the applied pressure is withdrawn, the occluding element substantially returns to its first or closed position.

For a better understanding of the present invention, together with other and further embodiments thereof, reference is made to the accompanying drawings and detailed description and its scope will be pointed out in the appended claims.

### BRIEF DESCRIPTION OF THE SEVERAL VIEWS OF THE DRAWING

FIG. 1 depicts a bird feed of the present invention;

FIG. 2 depicts a top view of the lid having a plurality of guards;

FIG. 3 depicts one embodiment of an occluding element; and

FIG. 4A-D depicts various embodiments of the occluding element.

### DETAILED DESCRIPTION OF THE INVENTION

The present invention relates to a bird feeder. In particular, the invention pertains to a bird feeder guard that serves as a barrier to contaminating animals, including insects, from entering a feed chamber of a bird feeder.

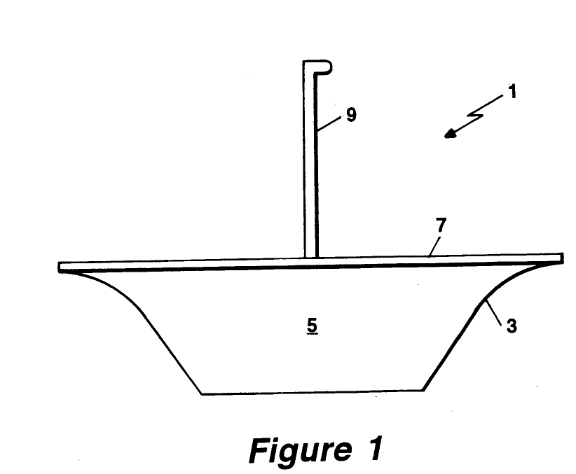

The bird feeder 1 of the present invention includes a housing 3 which defines a chamber 5. The chamber 5 houses food for birds, for example, nectar. See FIG. 1. The feeder 1 further includes a lid 7 that sits atop the housing 3. In one aspect, the housing 3 is defined by three surfaces. There is a basement surface and at least two lateral surfaces. The basement surface is disposed toward the “bottom” direction, as depicted in FIG. 1. (The terms “top” and “bottom” are arbitrary and are used only for the convenience of the reader.) The volume of the chamber 5 varies. For example, the volume of the chamber 5 can range from about 470 mL to about 960 mL. In one aspect of this embodiment, the feeder 1 includes a stalk 9 in order to suspend or otherwise attach the feeder 1 from or onto an attachment surface such as a tree branch or simply pole mounted.

The housing 1 can have any geometry, such as curvilinear forming a bowl-like structure. The geometry of the housing 1 can be a function of acute or oblong angles or a combination of both. The geometry of the housing 1 can be simple like a bowl, or more complex as one skilled in the art is acquainted. In one aspect, materials comprising the housing can withstand extremes of temperature ranging form about 0 to about 100+° C. Materials suitable for the housing 3 include, but not limited to, stainless steel, ceramic, copper, glass and plastics including polypropylene, polystyrene, ABS, SAN and alike.

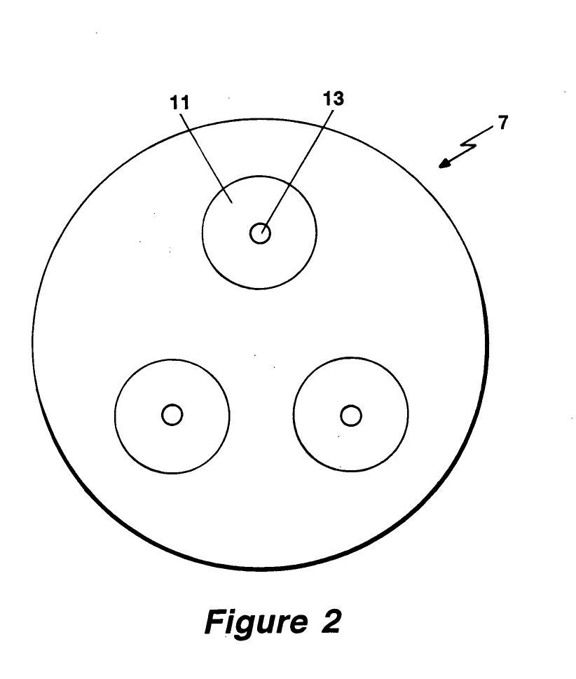

FIG. 2 depicts the perspective of one looking down onto the “top” of the lid 7. In one aspect, the lid 7 covers the entire top opening of the housing 3. Also depicted in FIG. 2 is a guard 11. In one aspect, this guard 11 is integrally formed within the lid 7. In another aspect, the guard 11 is a separate device that can be affixed onto or into the lid 7. The guard 11 is disposed along the lid 7, specifically, about an opening (not shown) in the lid 7. (This opening allows access to the chamber 5 for an animal outside of the feeder 1.) The guard 11 itself has an orifice 13 which facilitates communication between the exterior of the feeder 1 and the chamber 5.

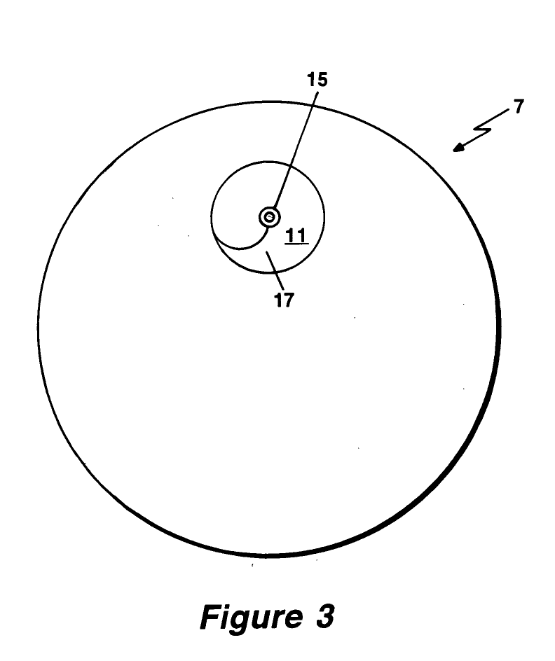

In one embodiment, the lid 7 of the present invention comprises a guard 11 that includes an orifice 13. Materials suitable for the lid include those mentioned above for the housing. In this embodiment, the guard orifice 13 is associated with an occluding element 15. See FIG. 3. This occluding element 15 is influenced by a biasing element 17. In one aspect, the occluding element 15 is of sufficient size as to completely occlude (may not have to completely occlude orifice, could partially occlude and still work) the orifice 13, thus not permitting any access to the chamber 5 from the exterior of the feeder 1. The geometry of the occluding element 15 is not limiting. For example, the occluding element 15 can have a generally spherical geometry. The occluding element 15 can have a flat-planar appearance. The important characteristic for this occluding element 15 is that when at rest (and in the absence of an externally applied pressure) it prevents entry into the chamber 5 from the exterior. Therefore, any geometry that can effectuate this requirement is deemed to be within the scope of this invention. Materials suitable for the occluding element 15 includes, but not limited to, plastics including polypropylene, polystyrene, ABS, SAN, ceramic, glass and metals including stainless steel and copper. (Note: the occluding and biasing element can also be made as one-piece.)

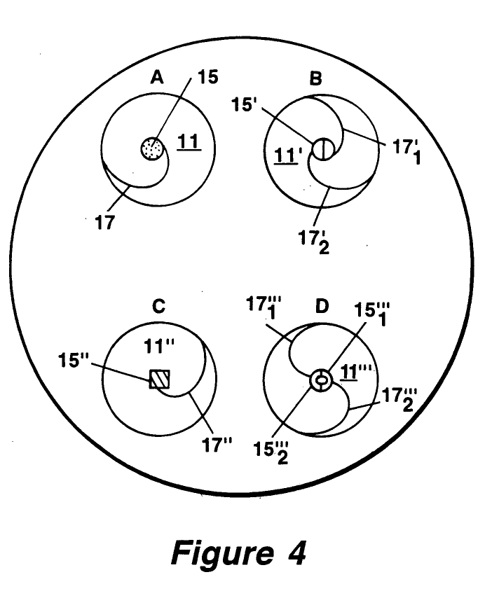

The biasing element 17 of the present invention can be secured by affixing one portion of the biasing element 17 to either the guard 11 or lid 7. A portion other than that already affixed is itself affixed to a portion of the occluding element 15. The method of affixation can be any method well known to those skilled in the art, such as welding, glue, ultra-sonic welding and staking, screwing, friction or interference fit, snap fit, others. More than one biasing element 17 can be employed per guard 11. For example, two or more biasing elements 17 can be affixed to the same occluding element 15 and be in opposition to one another (see FIG. 4, B & D). In another aspect, only one biasing element 17 is present (see FIG. 4, A & C). An example of a suitable biasing element 17 is a spring. In one aspect, the spring is made of a metal. Another example of a suitable biasing element 17 is a preformed, resilient material, such plastics including polypropylene, nylon, ABS, and SAN as well as steel wire.

When at rest, that is, when there is an absence of applied force upon the occluding element 15, the occluding element 15 is in a first position (or closed position). This first position is understood to mean that the occluding element 15 is securely positioned adjacent to an orifice 13 thus preventing entry of any undesirable animals into the chamber 5 from the exterior. It is conceivable that the occluding element 15 can be recessed partially or fully within the orifice 13. The force applied by the biasing element 17 upon the occluding element 15, when at rest, is sufficient to securely dispose the occluding element 15 adjacent to an orifice 13 such that access to the chamber 5 from the exterior is precluded. As a bird such as a hummingbird or oriole attempts to access the chamber 5 from the exterior, the orifice 13 will initially be blocked by the occluding element 15. In order for the bird to access the chamber 5, the bird will have to apply a sufficient amount of force upon the occluding device. A sufficient amount of force is that amount of force necessary to move the occluding element from its first position to its second position. In one aspect, the occluding element in our design has been tuned to deflect at weight force of four grams.

As the bird through its bill applies an external force upon the occluding element 5, the occluding element 5, if sufficient force is applied, will begin to be movably displaced into the second or opened position. The second position (or opened position) of the occluding element 15 is one where access from the exterior into the chamber 5 has been effectuated. Upon removal of the bird's bill, the biasing element 17 substantially repositions the occluding element 15 into its resting or first position.

The biasing element 17 of the present invention is designed to apply sufficient force to an occluding element 15 in order to maintain the occluding element 15 in its first or resting position, however, such force is not sufficient to preclude the ability of, for example, a Humming bird to gain access into the chamber 5 via penetration using its bill.

The occluding element 15 of the present invention is a device that is used to serve as a gate through which entry into the chamber 5 from the exterior is gained. Examples of suitable occluding elements include, but not limited to, a spherical device such as a ball (see FIG. 4A), one or more discs in opposition (see FIG. 4B), a flat-planar plate (see FIG. 4C), one or more spherical gates (see FIG. 4D), or it can be an elliptical, domed, triangular, square and alike occluding element. A fundamental requirement of the occluding element is that it prevents entry into the chamber by undesired animals small and large. In one aspect, the occluding element, together with the biasing element, is sufficiently designed so as to prevent entry into the chamber from the exterior by small insects, including all sizes of ants and bees. Such a design includes dimensions of the occluding element being large enough so as to occlude a guard orifice 13 (see FIG. 2) of the present invention and having sufficient tension from the biasing element so as to securely position the occluding element in the first position. For example, if the guard orifice has a diameter ranging from about 0.32 to about 8 mm, then the occluding element is of sufficient size to occlude an orifice having a diameter ranging not less than 0.36 or 9 mm. (Note: the hole can be bigger than the diameter of the occluding element. As long as the occluding either blocks or partially block the opening, it will work.)

Referring to FIG. 4A, there is shown a guard unit 11 having a spherical occluding element 15 affixed to a biasing element 17. The occluding element 15 can be a sphere (or ball) of a suitably resilient material. The occluding element 15 is depicted occluding a guard orifice (not shown). This is the first or resting position of the occluding element 15. This first position is secured by tension supplied by the biasing element 17 directed onto the occluding element 15. However, in one aspect, the first position need not be held in place under tension. As suitable external force is applied to the exterior facing surface of the occluding element 15, the occluding element 15 is displaced toward a second position. Suitable force can be applied, for example, by a bird using its bill in contact with the occluding element 15 and applying a force directly upon the occluding element 15. If sufficient force is applied, then the occluding element 15 will be displaced from the orifice (not shown). The bird can continue to enter the chamber of the feeder using its bill and obtain bird feed, for example, nectar. As the bird withdraws its bill from the feed chamber and exists via the orifice, the occluding element 15 returns to its first position under the influence of the biasing element 17.

Referring to FIG. 4B, there is shown a guard unit 11′ having a spherical occluding element 15′ affixed one or more biasing elements 17′. In one aspect, the occluding element 15′ can comprise two halves of a spherical device 15′_{1&2} (like a ball) of a suitably resilient material. The occluding element 15′ serves to occlude a guard orifice (not shown). This is the first or resting position of the occluding element 15′. This first position is secured by tension supplied by the biasing element 17′ directed toward the occluding element 15′. As a suitable external force is applied to the exterior facing surface of the occluding element 15′, the two halves of the occluding element 15′, are laterally displaced (in opposing direction) toward a second position. In one aspect, the occluding element 15′ can have a focal cavity on its exterior facing surface. This focal cavity can be disposed centrally about the occluding element thus serving as a focal receiving element for an externally applied force. Suitable or sufficient force can be applied, for example, by a bird using its bill in contact with the occluding element 15′ and applying a force directly upon the occluding element 15′. If sufficient force is applied, then the occluding element 15′ will be displaced from the orifice (not shown). For example, the two halves of the occluding element 15′_{1&2} can be laterally displaced in opposition to one another. The bird can continue to enter the chamber of the feeder using its bill and obtain bird feed, for example, nectar. As the bird withdraws its bill from the feed chamber and exists via the orifice, the occluding element 15′ returns to its first position under the influence of the biasing element 17′.

Referring to FIG. 4C, there is shown a guard unit 11″ having a flat-planar occluding element 15″ affixed to biasing element 17″. The occluding element 15″ can have a circular, rectangular geometry or any shape effective for occluding a guard orifice (not shown). The occluding element 15″ should comprise suitably resilient material. The occluding element 15″ in this figure is depicted occluding an orifice. This is the first or resting position (or closed position) of the occluding element 15″. This first position is secured by tension supplied by the biasing element 17″. As suitable or sufficient force is applied to the exterior facing surface of the occluding element 15″, the occluding element 15″ is displaced toward a second or opened position. A force can be applied, for example, by a bird using its bill in contact with the exterior facing surface of the occluding element 15″ and applying a force directly upon the occluding element 15″. If sufficient force is applied, then the occluding element 15″ will be displaced from the orifice (not shown). The bird can continue to enter the chamber of the feeder using its bill and obtain bird feed, for example, nectar. As the bird withdraws its bill from the feed chamber and exists via the orifice, the occluding element 15″ returns substantially to its first position via the biasing element 17″.

Referring to FIG. 4D, there is shown a guard unit 11′″ having a semi-circular disc-like occluding element 15′″ affixed to one or more biasing elements 17′″. Depicted in FIG. 4D is the employment of two biasing elements 17′″_{1&2}, each of which are affixed respectively to one of the halves _{1&2} of the occluding element 15′″. The occluding element 15′″ can comprise a suitably resilient material. The occluding element 15′″ serves as a gate, occluding a guard orifice (not shown). This is the first or resting position (or closed position) of the occluding element 15′″. This first position is secured by tension supplied by the biasing element 17′″. As suitable or sufficient force is applied to the exterior facing surface of the occluding element 15′″, the occluding element 15′″ is displaced toward a second or opened position. A force can be applied, for example, by a bird using its bill in contact with the occluding element 15′″ and applying a force directly upon the occluding element 15′″. As with the embodiment depicted in FIG. 4B, the occluding element 15′″ can have a focal point such as a cavity or small indent (or orifice). If sufficient force is applied, then the two halves _{1&2} of the occluding element 15′″ will be laterally displaced from the orifice (not shown). In one aspect, each semi-circular disc 15′″_{1&2} is laterally displaced in opposition to one another in response to sufficient force being applied, thus relieving an obstruction to the feed chamber. The bird can continue to enter the chamber of the feeder using its bill and obtain bird feed, for example, nectar. As the bird withdraws its bill from the feed chamber and exists via the orifice, the occluding element 15′″ returns to its first position via the biasing element 17′″.

It will be understood by those of ordinary skill in the art that other structures other than those depicted in FIG. 4 can be envisaged for the occluding element and still be within the scope of the present invention.

Although the invention has been described with respect to various embodiments, it should be realized this invention is also capable of a wide variety of further and other embodiments within the spirit and scope of the appended claims.

1. A bird feeder, comprising:
(a) a housing that defines a feed chamber, said housing includes a lid, wherein said lid has at least one opening; and
(b) a guard, said guard being formed integrally with said lid at said opening, wherein said guard includes an occluding element, said occluding element in communication with a biasing element, wherein said occluding element has a first position which blocks said opening sufficiently to prevent animals other than certain birds from gaining access to said feed chamber, said occluding element being movable to a second position by externally applied pressure to said occluding element thus permitting access to said chamber, said occluding element returning to substantially said first position when said applied pressure is withdrawn.

2. The bird feeder of claim 1, wherein said housing comprises at least three surfaces, wherein said surfaces are a basement surface, and at least two lateral surfaces.

3. The bird feeder of claim 1, wherein said feed chamber has a volume ranging from about 470 mL to about 960 mL.

4. The bird feeder of claim 1 further comprising a stalk that can facilitate suspension of said feeder from an attachment surface.

5. The bird feeder of claim 5, wherein said attachment surface is selected from the group consisting of a tree branch, and a pole mount.

6. The bird feeder of claim 1, wherein said housing has a curvilinear geometry.

7. The bird feed of claim 1, wherein said housing comprises materials selected from the group consisting of stainless steel, ceramic, copper, glass, and plastic.

8. The bird feeder of claim 7, wherein said plastic is selected from the group consisting of polypropylene, polystyrene, ABS, SAN, and alike.

9. The bird feeder of claim 1, wherein said guard comprises an orifice, wherein said orifice facilitates communication between the exterior of said feeder and said chamber.

10. The bird feeder of claim 1, wherein said lid comprises materials selected from the group consisting of stainless steel, ceramic, copper, glass, and plastic.

11. The bird feeder of claim 10, wherein said plastic is selected from the group consisting of polypropylene, polystyrene, ABS, SAN, and alike.

12. The bird feeder of claim 1, wherein said occluding element comprises materials selected from the group consisting of stainless steel, ceramic, copper, glass, plastic, polypropylene, polystyrene, ABS, and SAN.

13. The bird feeder of claim 1, wherein said occluding element is selected from the group consisting of a spherical device, one or more discs in opposition, a flat-planar plate, one or more spherical gates, and other devices having varied geometries.

14. The bird feeder of claim 13, wherein said other device having varied geometries is selected from the group consisting of elliptical, domed, triangular, square and alike devices.

15. The bird feeder of claim 13, wherein said spherical device is a ball.

16. The bird feeder of claim 1, wherein said occluding element has sufficient size so as to occlude said guard orifice when said occluding element is in said first position.

17. The bird feeder of claim 1, wherein said occluding element is a semi-circular disc-like element.

18. The bird feeder of claim 1, wherein said occluding element partially or completely blocks said guard orifice.

19. The bird feeder of claim 1 further comprising a biasing element.

20. The bird feeder of claim 19, wherein said biasing element is secured to (i) said guard or said lid and (ii) to said occluding element.
